(19) United States
(12) Patent Application Publication
(10) Pub. No.: US 2018/0352398 A1
(43) Pub. Date: Dec. 6, 2018

(54) Method, Device And User Equipment For Pushing Service Information

(71) Applicant: Shanghai Chule (Coo Tek) Information Technology Co., Ltd., Shanghai (CN)

(72) Inventors: Kan ZHANG, Shanghai (CN); Jialiang WANG, Shanghai (CN); Teng REN, Shanghai (CN); Xuesheng GONG, Shanghai (CN); Hengfeng TIAN, Shanghai (CN); Meng ZHANG, Shanghai (CN); Chenchen SHEN, Shanghai (CN); Zhiqiang ZHENG, Shanghai (CN); Chengxiao YANG, Shanghai (CN)

(73) Assignee: Shanghai Chule (Coo Tek) Information Technology Co., Ltd, Shanghai (CN)

(21) Appl. No.: 15/753,493

(22) PCT Filed: Aug. 22, 2016
(86) PCT No.: PCT/CN2016/096278

§ 371 Date: Jul. 20, 2018

(30) Foreign Application Priority Data
Aug. 20, 2015 (CN) 201510515350.6

(51) Int. Cl. H04W 4/20; H04L 29/08; H04M 1/725

(52) U.S. Cl. CPC H04W 4/20; H04L 67/306; H04M 1/72519; H04L 67/26

(57) ABSTRACT

This disclosure relates to a method, device and user equipment for pushing service information. The method comprises: monitoring a status of a call; determining whether to trigger a push of the service information based on the status of the call; acquiring at least one piece of the service information and a corresponding pushing manner based on the status of the call; and pushing at least one piece of the service information to a current call status interface. The present disclosure enables accurate pushing of service information to a user by taking into account the progress of the call.

### TECHNICAL FIELD

The present invention relates to the field of transmitting information over a network and, in particular, to a method, device and user equipment for pushing service information to a user.

### BACKGROUND

With the increasing ubiquity of the Internet and mobile Internet, service providers are introducing numerous Internet-based products in order to provide users with a wide range of services over the Internet. However, one of the urgent challenges facing them is how to successfully take greater market shares through pushing the developed services or applications to the general public, in particular to the expected target audience.

Advertising and other forms of promotion are playing an increasingly important role to services, applications or other products. On the one hand, accurate pushing specific to certain targets can help businesses maximize their advertising effectiveness. On the other hand, accurate advertising based on users' habits and needs can reduce harassment of unrelated users and mitigate their resistance. Nowadays, a great variety of mobile terminals provide a most convenient interface for users to access the Internet. Under the motivation of market demands, advertising systems have been developed that take advantage of such convenience provided by the mobile terminals to allow interaction between businesses and users.

Current approaches employed by the providers to promote their services or applications essentially include: 1) unidirectional advertising, such as TV commercials, subway advertisements, elevator advertisements and print advertisements everywhere around us, some of which may bear a quick response (QR) code for scanning by users; and 2) advertising combined with a simple service, such as advertisements displayed in front of taxi rear seats, which can convey simple service information.

However, the above approaches are both associated with deficiencies in terms of user experience and advertising effectiveness as detailed below.

The first approach may result in poor user experience because it only allows users to receive advertising information passively rather than actively based on their own preferences and needs or in a manner in which they can interact with the product or service providers.

The second approach is not much different from the first except for additionally providing some simple services. It fails to allow easy updates in the advertisements, and the audience is too general to allow tracking of their preferences and needs. Therefore, this approach is neither capable of accurate pushing.

### SUMMARY

To overcome the above problems, the inventors have found a solution by combining the pushing of service information about a service or application developed by an Internet service provider, with the progress of a call on the user equipment. In addition, another problem to be solved is how to achieve accurate pushing to a specific target. Further, the inventors presented that, since an Internet-based service or application usually requires interaction with users, its promotion or advertising should not be limited to simple demonstration of the service or application. Rather, an interaction interface is a better form to be provided to allow the user to immediately and conveniently enjoy the service within a limited duration of attention. Based on those all above, an object of embodiments of the present invention is raised, to solve one or more of the aforementioned problems.

According to one aspect of the present invention, there is provided a method of pushing service information. The method includes monitoring a status of a call; determining whether to trigger a push of the service information based on the status of the call; acquiring at least one piece of the service information and a corresponding pushing manner based on the status of the call; and pushing the at least one piece of the service information to a current call status interface.

According to another aspect of the present invention, there is provided a device for pushing service information. The device includes: a monitoring unit, adapted to monitor a status of a call; a push triggering determination unit, adapted to determine whether to trigger a push based on the status of the call; an acquisition unit, adapted to acquire at least one piece of the service information and a corresponding pushing manner based on the status of the call; and a pushing unit, adapted to push the at least one piece of the service information to a current call status interface.

According to a further aspect of the present invention, there is provided a computer program product implemented as a computer-readable storage medium. The computer program product comprises computer codes configured to perform the method according to the above aspect of the present aspect.

According to still another aspect of the present invention, there is provided a user equipment comprising the device according to the preceding aspect of the present aspect.

With various embodiments of the present invention, a service or application developed by an internet service provider can be pushed to a user while taking into account the progress of a call made by the user. This entails a novel approach to push service information to users. According to some embodiments of the present invention, accurate pushing is enabled to a specific target. According to some embodiments of the present invention, service information is pushed with interaction with the user being enabled.

These and other advantages and features of the present invention, together with the organization and manner of operation thereof, will become apparent from the following detailed description made with reference to the accompanying drawings, in the several figures of which like reference numerals identify like elements.

### BRIEF DESCRIPTION OF THE DRAWINGS

FIG. 1 is a flow diagram of a method for pushing service information in accordance with various embodiments of the present invention.

FIGS. 2a, 2b and 2c show exemplary service information pushed to and displayed on a call status interface of a user equipment in accordance with embodiments of the present invention.

FIG. 3 shows exemplary service information to be pushed which indicates some call-related functions of an application that supports phone calls in accordance with one embodiment of the present invention.

FIG. 4 shows a block diagram of a device for pushing service information in accordance with one embodiment of the present invention.

### DETAILED DESCRIPTION

The present disclosure will be described more fully below with reference to the accompanying drawings which illustrate embodiments of the disclosure. However, the disclosure may be embodied in many different forms and should not be construed as limited to the embodiments set forth herein. Rather, these embodiments are provided so that this disclosure will be thorough and complete, and will fully convey the scope of the disclosure to those skilled in the art.

The flowchart and block diagram in the Figures illustrate the architecture, functionality, and operation of possible implementations of devices, methods and computer program products according to various embodiments of the present invention. In this regard, each block in the flowchart or block diagram may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems which perform the specified functions or acts, or combinations of special purpose hardware and computer instructions.

As used herein, the term “service information” refers to, without limitation, information descriptive of a certain service or application which is generally provided by a third-party service provider over the Internet or mobile Internet. Service information may imply the ability of a service provider to provide a service, the possibility of a user to obtain a product or function from a service provider or the like. Service information may be descriptive information based on which a service provider promotes a service or application, such as an advertisement. Service information may also be information about a notification of an event relating to an application, a software version upgrade or the like.

The term “user equipment” is intended to cover any and all suitable electronic devices that support initiating or answering a call, including various mobile communication devices, non-mobile communication devices or combinations thereof. Examples of mobile communication devices may include, but not limited to, mobile terminals (e.g., cellphones), mobile computers, mobile phones, portable data processing devices, portable web browsers, portable gaming devices, portable digital cameras/camcorders, portable audio/video players, portable radio receivers, portable digital video recorders, portable pointing devices and portable wearable devices. Examples of non-mobile communication devices may include, but not limited to, desktop computers and laptop computers.

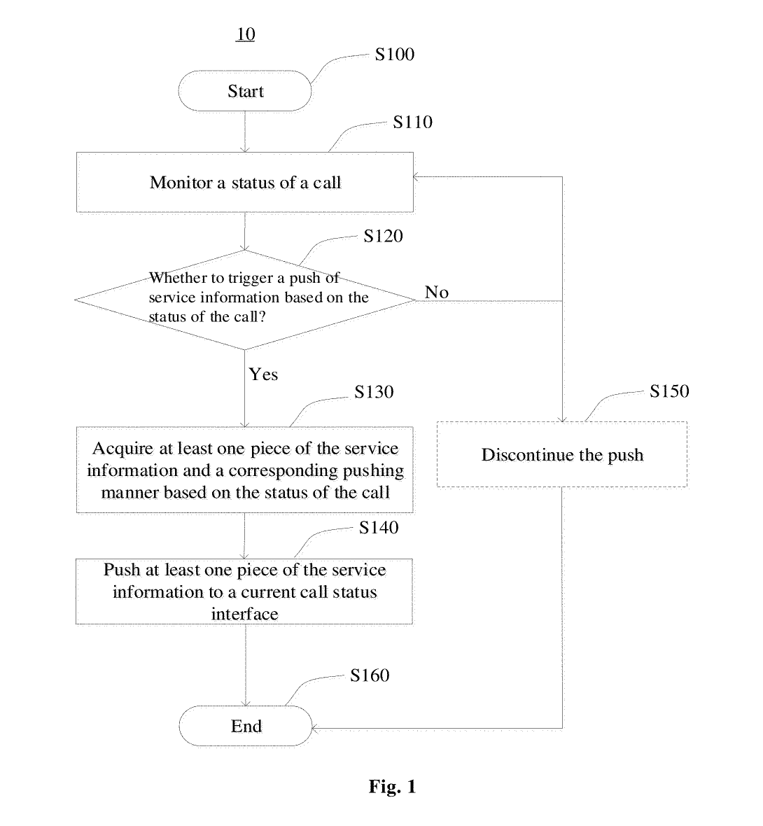

Referring to FIG. 1, a method 10 for pushing service information in accordance with various embodiments of the present invention is depicted via a flowchart. The method starts at step S100.

At step S110, a status of a call is monitored.

At step S120, it is determined whether to trigger a push of the service information based on the status of the call. It may be determined by a system- or user-defined condition. If it has been determined to trigger a push of the service information, the method 10 may proceed to step S130. Otherwise, it may loop back to step S110 and continue monitoring of the status of the call, or back to step S150.

At step S130, at least one piece of the service information, as well as a corresponding push method, is acquired based on the status of the call. At step S140, the at least one piece of the service information is pushed to a current call status interface.

After that, the method 10 ends at step S160.

According to another embodiment, the method may further include: at step S150, when it is determined that the status of the call no longer satisfies to trigger a push of the service information, discontinuing the push.

According to still another embodiment, the method may further include: at step S112, determining whether to trigger a download of the service information and if the triggering is confirmed, acquiring the service information.

According to various embodiments of the present invention, the status of the call may be, for example, one or more of ongoing entry of information of a called user by the calling user, waiting to be answered, starting to be answered, ongoing in a hands-free mode, ongoing in an earphone mode, ongoing with a screen being brought into the vicinity of the calling user, terminated with a call interface still being active, and being redirected. According to some embodiments, in an Android platform, PhoneStateListener.LISTEN_CALL_STATE may be called to monitor the status of the call, such as “Ringing”, “Offhook”, “Idle”, etc.

The entry of the information of the called user by the calling user may be entry of a phone number thereof or selection of an entry therefore from a contact list in a user equipment of the calling user.

In addition, the method may further include detecting a screen status of the user equipment during the call to find whether the screen is, for example, being locked or lit up or not.

According to various embodiments of the present invention, it may be so configured beforehand that the push is triggered upon the call being in one or more of the following statuses: ongoing entry of information of a called user by the calling user, waiting to be answered, ongoing in a hands-free mode, ongoing in an earphone mode, terminated with an application for the call still being active and ongoing with the screen being lit up. Additionally, it is also possible to determine whether to trigger the push based on both the status of the call and the screen status.

For example, the push may be triggered when the screen is lit up while the call is waiting to be answered or when the call has been terminated with the application for the call still being active. In another embodiment, the push may be triggered when the call is ongoing in a hands-free mode or is waiting to be answered.

It will be appreciated that the application for the call may be a dialing application installed on the user equipment either initially by the manufacturer of the user equipment or by a third party (e.g., TouchPal Smart Dialer from Shanghai Chule (Cootek) Information Tech Co., Ltd. and WeChat from Tencent Holdings Limited). Various embodiments of the present invention may be combined with or integrated into these dialing applications.

Each piece of the service information may include a content field defining how the service information is rendered on the call status interface of the user equipment. Data may include, but not limited to, text, pictures, voices, videos, animations, htm15 pages or a combination thereof. It may further include an action field indicative of an action that can be taken (e.g., executing an instruction) on the rendered service information in response to a manipulation of the user (e.g., a single click or a selection), such as for example, clicking a like button (i.e., showing an appreciation for or support to the service), adding into favorites (i.e., saving the service information as a favorite), skipping playing (i.e., skipping the rendering of the service information), commenting (i.e., writing down a comment to the service information by the user), accessing a service (e.g., opening a HTML page, dialing a phone number, displaying text or a picture or operating an application, that is indicated in the content field of the service information), page redirection (i.e., redirecting to another page) or accessing a guide to a specific function (e.g., a user guideline to the service, application or a certain function thereof). The action field allows the user to interact with the service information rendered on the call status interface.

It will be appreciated that various embodiments of the present invention may be implemented either at the user equipment or at a server that communicates with the user equipment (e.g., via the Internet or mobile Internet) and provides the service information. In the former case, for example, the user equipment can download the service information to be pushed from the server when it is determined to trigger the download is satisfied. In the latter case, for example, the user equipment may need to inform the server of the monitored status of the call, the defined condition for triggering the push and other information.

In one embodiment, upon the user activating a third-party dialing application on a cellphone, such as for example, TouchPal Smart Dialer from Shanghai Chule (Cootek) Information Tech Co., Ltd., step S110 is performed to monitor a status of the call. When it has been detected that the status of the call satisfies to trigger a push of an advertisement, the advertisement is pushed. The push may be triggered during a waiting period from when the calling user has entered information of a called user to initiate the call to when the called user answers the call or after the call has been terminated with the dialing application remaining active.

Prior to detecting whether the status of the call satisfies to trigger the push, it is possible to detect whether to trigger a download. If the determination is positive, the advertisement may be downloaded in the backend of the cellphone, and the download may be terminated upon its completion or in response to a detected instruction for the termination. Additionally, a current network condition may be detected, and the download of the advertisement may be triggered upon detected available network accessibility.

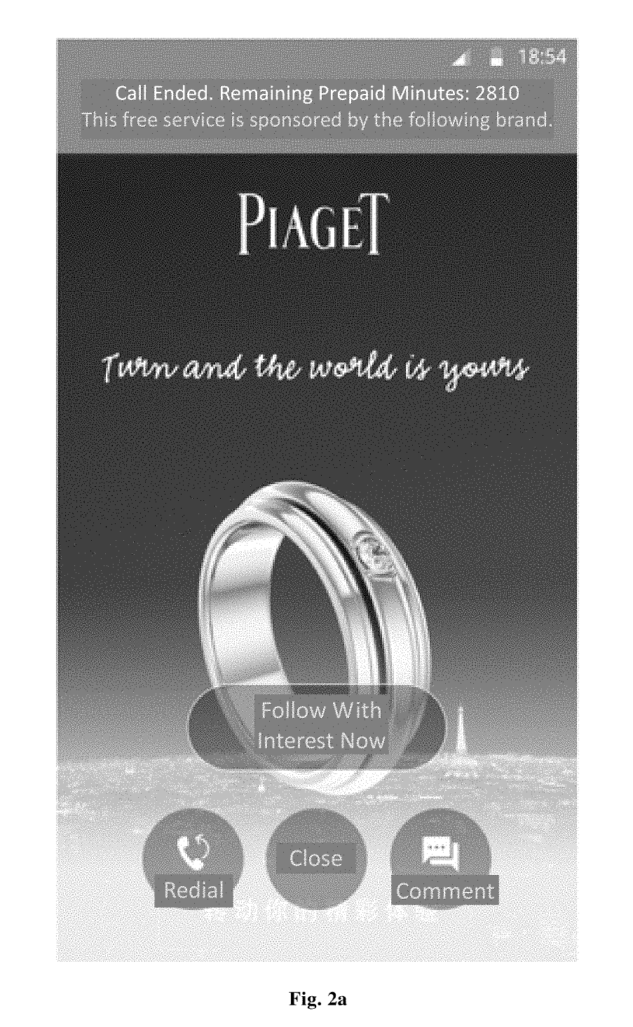

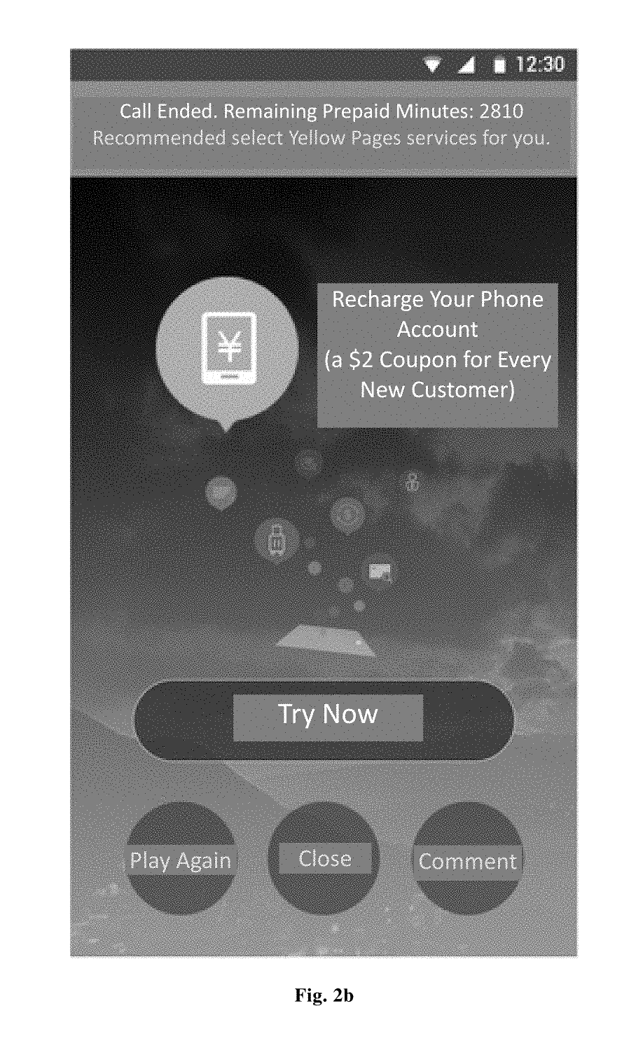

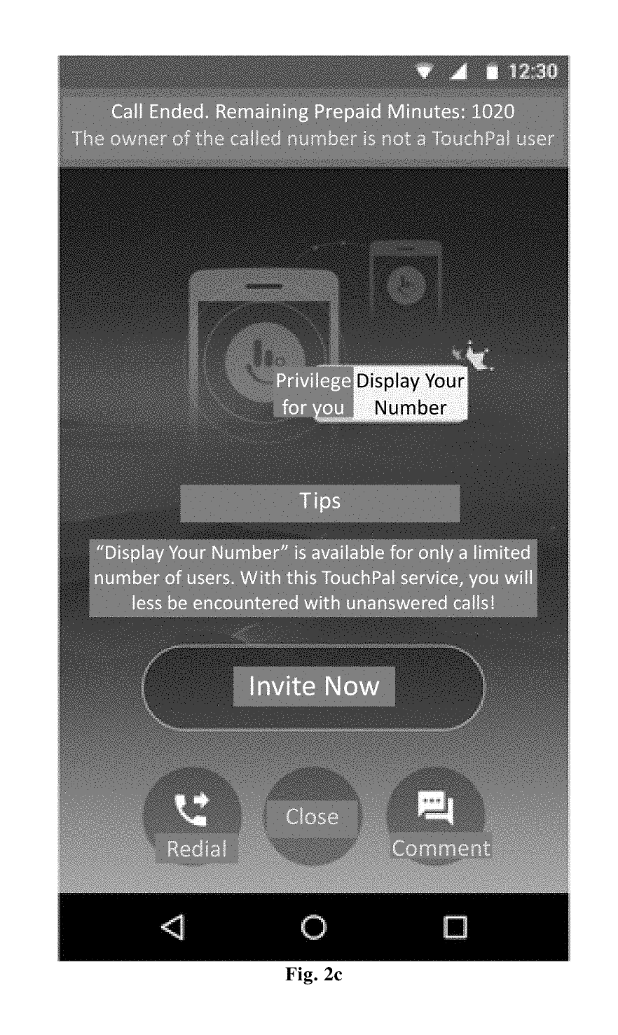

Reference is now made to FIGS. 2a, 2b and 2c, each showing an advertisement pushed to and displayed on a call status interface of the cellphone. The advertisement may include one or more of a picture, a voice, a video, an animation and a HTML5 page. The advertisement illustrated in FIG. 2 assumes the form of a picture.

Additionally or alternatively, data in the action field of the service information may be acquired so that the user can interact with the service information rendered on the call status interface to enjoy the service indicated in the service information. This, for example, allows fast, convenient access to an advertised service. In the embodiment shown in FIG. 2b, the service information may be rendered with its content field displayed as the text “Recharge Your Phone Account (a $2 Coupon for Every New Customer)” on top of a picture and its action field as a “Try Now” virtual button on the screen of the cellphone. In response to a detected manipulation of the user on the virtual button, an action indicated in the action field is carried out to, for example, open a page that provides the user with an access to the service, i.e., recharging his phone account (and getting a $2 coupon if he is a new customer).

Additionally or alternatively, the data in the content field of the advertisement may further include a guide to the advertised service or application or a function thereof. As shown in FIG. 2c, upon determination whether to trigger the push based on the status of the call (e.g., terminated), a corresponding one of the aforementioned fields of the service information may be rendered on the call status interface. For example, the data in the content field of the service information may be rendered as a picture showing a function of the third-party dialing application to display the calling number or as a guide to the function (including a “Display Your Number” virtual button containing a video link). Alternatively, data in the action field of the service information may be rendered as a representation providing the called user with an access to the third-party dialing application (e.g., a “Invite Now” virtual button). Upon a detected manipulation on the “Display Your Number” virtual button, data associated therewith may be acquired to display an introduction to the function and/or a video guide to how to configure it.

According to an embodiment of the present invention, step S130 may include matching the service information to be pushed with a pre-stored user profile, acquiring related piece(s) of the service information according to a result of the matching and pushing the related service information to the user equipment only if a match is found therebetween. The matching step may be implemented either at the user equipment or at the server providing the service information. Accordingly, the user profile may be stored either partially or entirely on the user equipment or collectively at the server that provides the service information.

In one embodiment, the service information may be promotional information on services or applications or may be advertisements. The advertisements may be stored on an advertisement server that provides information about the advertisements, for example, on the server itself or a database connected thereto. Alternatively, they may also be allocated by the advertisement server to the user equipment and stored on a local database thereof.

Each of the advertisements may include a plurality of data fields such as, for example, those indicative of a rendering type, identifier (ID), url link to a picture, associated action and the like. Additionally, it may also include data fields representing a title, description of features and the like of the advertisement. The action data field may be used to describe an action performed in response to a detected user manipulation on the pushed advertisement.

As an example, the user profile may include one or more of system information on the user's mobile device (e.g., model, manufacturer, operating system and version of the cellphone, SIM operator, location data, networking conditions, etc.), the user's preference information (e.g., applications installed by the user, frequently viewed contents, etc.), call information (e.g., remaining prepaid minutes and traffic, search history or the like in a certain application of the user that supports phone calls) and information about a history of manipulations by the user (advertisements that have been played, blocked, liked and commented).

After the advertisements are transmitted from the advertisement server to the database of the user equipment, they may be matched with the user profile so as to find the one(s) having a degree of relevance to the user profile within a predefined threshold range. When the status of the call satisfied to trigger a download, the matched advertisement(s) is/are downloaded. Alternatively, the matching of the advertisements in the database with the user profile may also be carried out when the status of the call satisfies to trigger the push to find the one(s) having a degree of relevance to the user profile within the predefined threshold range, followed by pushing of the matched advertisement(s). In one embodiment, the matched advertisement(s) may be further screened, and the selected advertisement(s) from the screening may be pushed to the call status interface.

In one embodiment, the service information may indicate call-related functions of a software application that supports phone calls. FIG. 3 shows these functions and their associated content and action fields. According to some embodiments, step S130 may further include acquiring user data of the software application and determining a type of the user based the user data. Subsequently, piece(s) of service information that match/matches the type of the user may be acquired, and data in the content and action fields of the acquired service information may be pushed. This allows directionally providing a recommended function to a user who satisfies a predefined condition.

Alternatively, according to another embodiment of the present invention, step S130 may further include matching the service information to be pushed with a predefined filtering/acceptance rule and acquiring the corresponding pushing manner so that only the piece(s) of the service information that meet/meets the filtering/acceptance rule is/are pushed to the user equipment.

In one embodiment, prior to the pushing of the service information (e.g., advertisements), for example, a status of software running on the mobile device may be detected in real time, and the corresponding pushing manner may be acquired based on a result of the detection. For example, if an ongoing screen lock software program, third-party application or call session (e.g., the call is being answered (not in a hands-free mode) is detected, the push is given up. Further, different pushing manners may be selected depending on the status of the call. For instance, depending on the call detected as being in one of the following statues: just initiated, waiting to be answered and starting to be answered, different pushing manners may be selected to push the service information, such as advertisement(s) selected from an accurate matching based on the user's preferences and needs, to the current call status interface. The user's preferences and needs may be used as a screening rule for screening for service information favorable to the user and may be predefined by the user.

Furthermore, in the pushing mode, data on the playing of the advertisement may be collected, statistically processed and summarized. For example, in a detected advertisement playing mode, an area of the screen in which the advertisement is played may be monitored. Upon detecting a manipulation of the user, a determination may be made based on the user's manipulation, and an instruction may be retrieved and executed based on a result of the determination. For example, when a tap of the user is detected at a predefined location during the playing of the advertisement, the predefined location may be determined based this user input, which may in turn serve as a basis for acquiring an instruction corresponding to the tap for, for example, clicking a like button, adding to favorites, skipping playing or the like. The instruction is then executed. Additionally, the user may also be allowed to add a comment to the played advertisement. According to embodiments of the present invention, a degree of matching between the current advertisement and the user may be modified through detecting and collecting the user's manipulations. This can further increase the accuracy in pushing the advertisement. Alternatively, based on the detected and collected manipulations of the user, it is also possible to guide the user to download the matching advertisement(s). This can result in improved downloading and matching accuracy of the advertisements.

According to one embodiment of the present invention, step S130 may further include, in the current status of the call, detecting an interaction between the user and the device and acquiring the pushing manner based on both the current status of the call and the interaction.

After the user takes out the mobile phone, monitoring of the current status of the call may be initiated. Upon detecting ongoing entry of a number by the user, the push is not carried out. When the entry of the number of the completed and a dial key is pressed by the user, the cellphone will be detected as being in a status of waiting for the call to be answered. At this point, the advertisement(s) selected from the screening may be pushed. If the call ends unanswered or is ended, it will be detected that the waiting status of the call is terminated, and the push may be discontinued. With the call being completed, if a press on a hang up button by the user or the termination of the call is detected, the push may be resumed. The push may be again discontinued upon detection a subsequent manipulation of the user such as, for example, locking the screen, pressing a key or inserting an earphone.

Additionally or optionally, the pushing manner may be determined further based on a result of detecting the screen status. For example, after the call starts being answered, the screen status may be again determined. If it is determined that the call is answered in a hands-free or earphone mode, the screen status may be determined for another time. If the screen is lit up, then the advertisement(s) may be pushed; otherwise, if the screen is not lit up or remains in a standby status, the pushed may be given up. Additionally, if the call is answered with the user holding the device close to the ear, the push may be given up.

In the foregoing case, a condition for pushing the advertisement(s) may be chosen beforehand, or step S150 may be carried out to discontinue the push in real time when it is detected that the status of the call no longer satisfies to trigger the push.

In one embodiment, in step S140, the matching advertisement(s) acquired based on the user profile may be selected and prioritized. For example, degree(s) of relevance of the matching advertisement(s) to the user may be calculated, and the advertisement with the highest degree of relevance may be played at the first place.

In one embodiment, the advertisements may be matched with the user profile to find the one(s) accurately matching the user, wherein each of the advertisements may comprise data fields indicating a type, industry, content, form, target population, brand of the advertisement, as well as a prompt to the user to perform a screening based on these data fields beforehand or a matching with the user profile so as to obtain the screening result. This allows the user to actively select advertisements of desired type(s) and content to create a list of favorite advertisements and define conditions for their display, for example, before the call is answered or after it is terminated.

In one embodiment, the advertisement playing mode is exited upon a detected incoming call or activation of a third party application.

According to various embodiments of the present invention, the push service information may be rendered in a full screen, half-screen or splash screen. In each of these cases, an area is reserved on the interface on which the service information is rendered for displaying a current status of the user equipment, for example, “Call ended” on the top of the screen, as shown in FIGS. 2a, 2b and 2c.

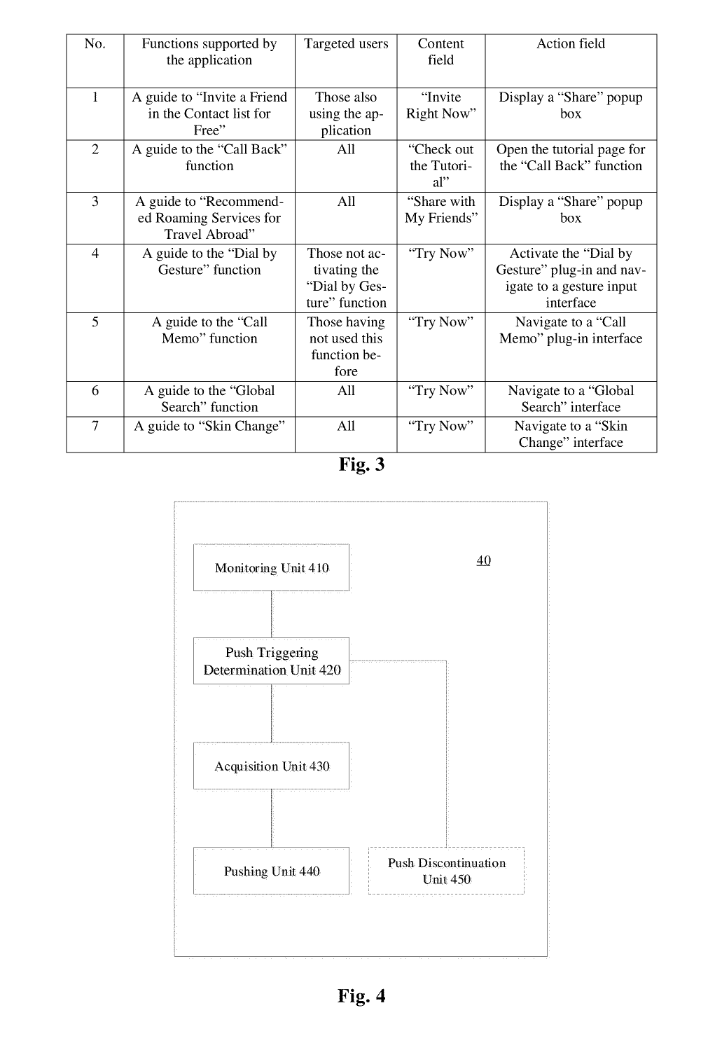

Referring to FIG. 4, a device 40 for pushing service information according to one embodiment of the present invention is schematically illustrated. The device 40 includes: a monitoring unit 410, adapted to monitor a status of a call; a push triggering determination unit 420, adapted to determine whether to trigger a push of the service information based on the status of the call; an acquisition unit 430, adapted to acquire at least one piece of the service information and a corresponding pushing manner based on the status of the call; and a pushing unit 440, adapted to push the at least one piece of the service information to a current call status interface.

The device 40 may further include a push interrupt unit 450, adapted to discontinue the push when the push triggering determination unit 420 determines that the status of the call no longer satisfies to trigger the push.

It will be appreciated that the units in the device 40 correspond to the respective steps in the method 10. Therefore, the operations and features described above with reference to FIG. 1 also apply to the device 40 and the units thereof, and a full description thereof is deemed unnecessary herein.

It will be also appreciated that the device 40 may be implemented in various manners. For example, in some embodiments, the device 40 may be implemented in software components and/or firmware modules. In addition, the device 40 may also be implemented in hardware modules. Further, it may be implemented in other ways known or developed in the future, and the present invention is not limited in this regard.

Although the service information has been described as advertisements in the foregoing several embodiments, it will be appreciated that the service information may also be information on event notifications about an application, version upgrades or the like.

According to various embodiments of the present invention, the pushing of the service information may be combined with the progress of a call on a user equipment, thereby entailing a novel method for conveniently pushing service information to the user. In particular, embodiments of the invention offer at least the following advantages:

1) it enables screening of service information based on users' preferences and needs and accurate pushing of the service information to users with different demands;

2) it allows users to directly access to a service advertised in a piece of service information simply by a click;

3) users are allowed to select their own favorite services from a variety of categories of service information or define screening condition for finding service information of interest, and to select the forms or manners in which the service information is rendered, for example, in a predefined area of the call status interface; and

4) a call-related status of the user equipment can be detected so that the service information is only pushed when there is no ongoing call.

The teachings of the present invention may also be embodied in a computer program product implemented as a computer-readable storage medium storing computer program codes which, when processed by a processor, cause the processor to perform the methods for pushing service information according to embodiments of the present invention. The computer-readable storage medium may be any tangible medium such as a floppy disk, CD-ROM, DVD, hard drive or even network medium.

While detail description of the present invention has been presented above for the purposes of illustration and explanation, it is not intended to be exhaustive or limit the disclosed invention in any sense. Many modifications and variations are conceivable to those skilled in the art upon reading this disclosure. The various embodiments described above can be used alone or in various combinations, unless the context expressly provides otherwise. It will be appreciated by those skilled in the art that the methods and devices according to the embodiments of the invention may be implemented in software, hardware, firmware, or a combination thereof.

Thus, the disclosed embodiments are described in order for those of ordinary skill in the art to understand the principles and practical application of the present invention. That is, all changes and substitutions made without departing from the spirit of the invention will fall within the scope thereof as defined by the appended claims.

1. A method of pushing service information, comprising:
monitoring a status of a call;
determining whether to trigger a push of the service information based on the status of the call;
acquiring at least one piece of the service information and a corresponding pushing manner based on the status of the call; and
pushing at least one piece of the service information to a current call status interface.

2. The method of claim 1, wherein the status of the call comprises at least one of:
the progress status of the call;
a user-to-screen distance; and
a screen status of a user equipment.

3. The method of claim 1, wherein pushing at least one piece of the service information to the current call status interface further comprises:
matching the service information with a user profile to acquire the at least one piece each having a degree of relevance within a predefined range; and when the status of the call satisfies to trigger the push, pushing the at least one piece that matches the user profile to the user equipment.

4. The method of claim 3, wherein the user profile comprises one or more of: system information on the user equipment, information on preferences of the user, information on a call quota of the user and information on a history of manipulations of the user.

5. The method of claim 3, further comprising: prioritizing the service information to be pushed based on degrees of matching.

6. The method of claim 1, wherein pushing the at least one piece of the service information to the current call status interface further comprises:
pushing the at least one piece that each meets a predefined filtering/acceptance rule to the user equipment.

7. The method of claim 1, wherein pushing the at least one piece of the service information to the current call status interface further comprises:
detecting an interaction between the user and the user equipment, acquiring the pushing manner based on both the status of the call and the interaction, and pushing the at least one piece to the current call status interface based on the pushing manner.

8. (canceled)

9. The method of claim 1, wherein the service information further comprises an action field associated with the content field, the action field being adapted to indicate an action performable on the content field.

10. (canceled)

11. (canceled)

12. The method of claim 1, further comprising: detecting a manipulation of the user, acquiring the action field that corresponds to an object on which the manipulation is performed and executing the action field, thereby accomplishing an interaction.

13. The method of claim 1, further comprising: detecting and collecting the interaction of the user and modifying the degrees of matching based on a result of the collection.

14. The method of claim 1, wherein when it is determined whether to trigger the push is no longer satisfied, the push is discontinued.

15. A device for pushing service information, comprising:
a monitoring unit, adapted to monitor a status of a call;
a push triggering determination unit, adapted to determine whether to trigger a push based on the status of the call;
an acquisition unit, adapted to acquire at least one piece of the service information and a corresponding pushing manner based on the status of the call; and
a pushing unit, adapted to push the at least one piece of the service information to a current call status interface.

16. The device of claim 15, further comprising:
a push interrupt unit, adapted to discontinue the push when the push triggering determination unit determines that the status of the call no longer satisfies to trigger the push.

17. The device of claim 15, wherein the status of the call comprises at least one of: the progress of the call; a user-to-screen distance; and a screen status of a user equipment.

18. The device of claim 15, wherein the acquisition unit is further adapted to match the service information with a user profile to acquire the at least one piece thereof each having a degree of relevance within a predefined range.

19. (canceled)

20. The device of claim 15, wherein the acquisition unit is further adapted to push the at least one piece of the service information that each meets a predefined filtering/acceptance rule to the user equipment.

21. The device of claim 15, wherein the acquisition unit is further adapted to detect an interaction between the user and the user equipment and acquire the pushing manner based on both the status of the call and the interaction.

22. The device of claim 15, wherein the service information further comprises an action field associated with the content field, the action field being adapted to indicate an action performable on the content field.

23. The device of claim 22, wherein a manipulation of the user is detected and the action field that corresponds to an object on which the manipulation is performed is acquired and executed, thereby accomplishing an interaction.

24. The device of claim 23, wherein the interaction of the user is detected and collected and the degrees of matching are modified based on a result of the collection.

25. A user equipment comprising the device as defined in claim 15.
